(19) United States
(12) Patent Application Publication
(10) Pub. No.: US 2026/0064114 A1
(43) Pub. Date: Mar. 5, 2026

(54) MULTI-TYPE ROBOT INTEGRATED CONTROL AND MONITORING SYSTEM AND METHOD PERFORMING MISSING STATE DATA ESTIMATION

(71) Applicant: BIGWAVE ROBOTICS CORP., Seoul (KR)

(72) Inventors: Hoyoung SHIN, Seoul (KR); Byeonguk PARK, Seoul (KR); Junbong SONG, Seoul (KR)

(73) Assignee: BIGWAVE ROBOTICS CORP., Seoul (KR)

(21) Appl. No.: 19/366,916

(22) Filed: Oct. 23, 2025

Related U.S. Application Data
(63) Continuation of application No. PCT/KR2025/012887, filed on Aug. 25, 2025.

(30) Foreign Application Priority Data
Sep. 2, 2024 (KR) 10-2024-0118338
Sep. 2, 2024 (KR) 10-2024-0118341
Sep. 2, 2024 (KR) 10-2024-0118346

(51) Int. Cl. G05D 1/226; G05D 1/222; G05D 101/00

(52) U.S. Cl. CPC G05D 1/2265; G05D 1/222; G05D 2101/22

(57) ABSTRACT

Disclosed is an integrated control system for multiple types of robots includes: a robot message standardization server configured to transmit and receive status and command messages in unique format to and from multiple types of robots; and a robot data processing server configured to transmit and receive status and command messages in a standard format to and from the robot message standardization server. The robot message standardization server receives status messages in the unique format from the multiple types of robots, converts the status messages in the unique format into status messages in the standard format according to a standardization protocol, and transmits the status messages in the standard format to the robot data processing server.

### CROSS-REFERENCE TO RELATED APPLICATIONS

The present application is a continuation of International Patent Application No. PCT/KR2025/012887, filed on Aug. 25, 2025, which is based upon and claims the benefit of priority to Korean Patent Application Nos. 10-2024-0118338, 10-2024-0118341, and 10-2024-0118346, filed on Sep. 2, 2024, Sep. 2, 2024, and Sep. 2, 2024, respectively. The disclosures of the above-listed applications are hereby incorporated by reference herein in their entirety.

### BACKGROUND

Embodiments of the inventive concept described herein relate to an integrated control system and method for multiple types of robots that are capable of performing the estimation of missing status data.

### SUMMARY

The inventive concept provides an integrated control system and method for multiple types of robots that are capable of performing the estimation of missing status data.

The technical objects of the inventive concept are not limited to the above-mentioned ones, and the other unmentioned technical objects will become apparent to those skilled in the art from the following description.

In accordance with an aspect of the inventive concept, there is provided an integrated control system for multiple types of robots, the integrated control system including: a robot message standardization server configured to transmit and receive status and command messages in unique format to and from multiple types of robots; and a robot data processing server configured to transmit and receive status and command messages in a standard format to and from the robot message standardization server; wherein the robot message standardization server: receives status messages in the unique format from the multiple types of robots, converts the status messages in the unique format into status messages in the standard format according to a standardization protocol, and transmits the status messages in the standard format to the robot data processing server; and receives command messages in the standard format from the robot data processing server, converts the command messages in the standard format into command messages in the unique format according to the standardization protocol, and transmits the command messages in the unique format to the multiple types of robots; and wherein the robot data processing server: generates robot status information based on the status messages in the standard format received from the robot message standardization server, and transmits the robot status information to user devices of the integrated control system for multiple types of robots; generates command messages in the standard format based on user command information received from the user devices, and transmits the command messages in the standard format to the robot message standardization server; and, when for one or more robots, one or more pieces of status data are inherently missing from the status messages in the unique format and thus one or more pieces of status data are omitted from the status messages in the standard format, estimates values of the one or more pieces of missing status data based on a user command history stored in a robot database.

In accordance with another aspect of the inventive concept, there is provided an integrated control method for multiple types of robots, the integrated control method being performed by an integrated control system for multiple types of robots including a robot message standardization server and a robot data processing server, the integrated control method including: transmitting and receiving, by the robot message standardization server, status and command messages in unique format to and from multiple types of robots; and transmitting and receiving, by the robot data processing server, status and command messages in a standard format to and from the robot message standardization server; wherein transmitting and receiving the status and command messages in the unique format includes: by the robot message standardization server, receiving status messages in the unique format from the multiple types of robots, converting the status messages in the unique format into status messages in the standard format according to a standardization protocol, and transmitting the status messages in the standard format to the robot data processing server; and receiving command messages in the standard format from the robot data processing server, converting the command messages in the standard format into command messages in the unique format according to the standardization protocol, and transmitting the command messages in the unique format to the multiple types of robots; and wherein transmitting and receiving the status and command messages in the standard format includes: by the robot data processing server, generating robot status information based on the status messages in the standard format received from the robot message standardization server, and transmitting the robot status information to user devices of the integrated control system for multiple types of robots; generating command messages in the standard format based on user command information received from the user devices, and transmitting the command messages in the standard format to the robot message standardization server; and, when for one or more robots, one or more pieces of status data are inherently missing from the status messages in the unique format and thus one or more pieces of status data are omitted from the status messages in the standard format, estimating values of the one or more pieces of missing status data based on a user command history stored in a robot database.

The other detailed items of the inventive concept are described and illustrated in the specification and the drawings.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a diagram schematically showing an example of an environment in which an integrated control system for multiple types of robots according to one embodiment of the inventive concept is provided;

FIG. 2 is a diagram schematically showing a network connection between an integrated control system for multiple types of robots, robots, pieces of automated equipment, and user devices according to one embodiment of the inventive concept;

FIG. 3 is a diagram schematically showing a connection structure between the integrated control system for multiple types of robots, robots, and pieces of automated equipment of FIG. 2;

FIG. 4 is a diagram schematically showing an example of the configuration of the robot of FIG. 2;

FIG. 5 is a diagram schematically showing the configuration of an integrated control system for multiple types of robots according to one embodiment of the inventive concept;

FIG. 6 is a diagram schematically showing the functions or services performed by an integrated control system for multiple types of robots according to one embodiment of the inventive concept;

FIG. 7 is a diagram schematically showing the server configuration of an integrated control system for multiple types of robots according to one embodiment of the inventive concept;

FIG. 8 is a diagram schematically showing message conversion using a standardization protocol according to some embodiments of the inventive concept;

FIG. 9 is a diagram schematically showing an integrated control method for multiple types of robots performed by the integrated control system for multiple types of robots of FIG. 7;

FIG. 10 is a diagram schematically showing the detailed configuration of step S700 of FIG. 9;

FIG. 11 is a diagram schematically showing the detailed configuration of step S800 of FIG. 9;

FIG. 12 is a diagram schematically showing an example of a standardization protocol;

FIG. 13 is a diagram schematically showing the process of the standardization conversion of a status message using the example of the standardization protocol of FIG. 12;

FIG. 14 is a diagram schematically showing message conversion using a common standardization protocol and a dedicated standardization protocol according to some embodiments of the inventive concept;

FIG. 15 is a diagram schematically showing the detailed configuration of step S710 of FIG. 10;

FIG. 16 is a diagram schematically showing the detailed configuration of step S720 of FIG. 10;

FIG. 17 is a diagram schematically showing an example of the process of the standardization conversion of status messages using a common standardization protocol and dedicated standardization protocols according to some embodiments of the inventive concept;

FIG. 18 is a diagram schematically showing estimating missing status data by using a robot database according to some embodiments of the inventive concept;

FIG. 19 is a diagram schematically showing the detailed configuration of step S810 of FIG. 11;

FIG. 20 is a diagram schematically showing an example of the status data omission that occurs during the process of the conversion of status messages using a standardization protocol according to some embodiments of the inventive concept; and

FIG. 21 is a diagram schematically showing an example of the user interface of an integrated control system for multiple types of robots according to some embodiments of the inventive concept.

### DETAILED DESCRIPTION OF THE DISCLOSURE

The above and other aspects, features and advantages of the invention will become apparent from the following description of embodiments given in conjunction with the the following accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

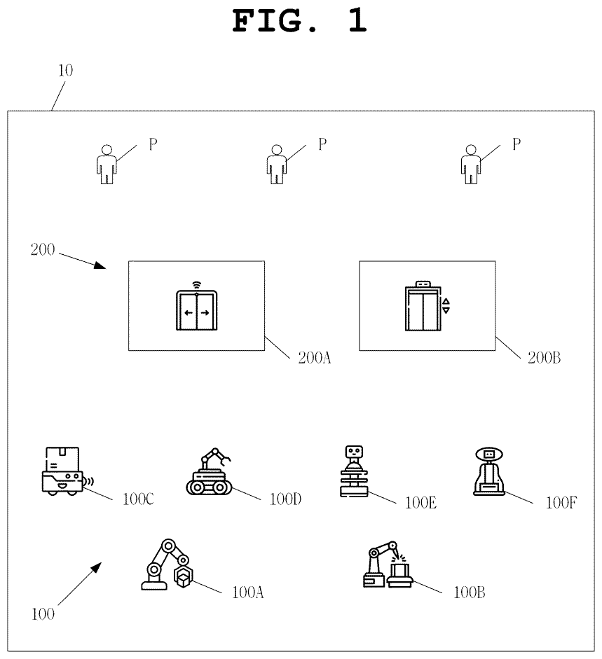

FIG. 1 is a diagram schematically showing an example of an environment in which an integrated control system for multiple types of robots according to one embodiment of the inventive concept is provided.

Referring to FIG. 1, one or more robots 100, one or more pieces of automated equipment 200, and one or more persons P may be present inside a site 10 in which the integrated control system for multiple types of robots is provided.

The site 10 represents a space where the one or more robots 100 are introduced (installed or provided) and controlled. For example, the site 10 may be one of various types of indoor spaces, such as a factory, a hospital, a school, an airport, an apartment, a studio apartment, an office, a restaurant, a government office, a gymnasium, a shopping mall, and a subway station. The site 10 may be a single-story building or a multi-story building having two or more floors. Alternatively, the site 10 may be an outdoor space. Meanwhile, a plurality of sites 10 may be implemented within a single space as needed. For example, when the first and second floors of a building are designated as separate sites 10, the first floor may be designated as a first site 10, and the second floor may be designated as a second site 10.

Multiple types of robots 100A to 100F may be present within the site 10.

The “robot” refers to a mechanical device programmed to perform a variety of tasks. The robot includes robots having a variety of applications and functions utilized in various industrial and service fields. For example, the robot includes various types of robots such as: industrial robots, such as Cartesian robots, multi-joint robots, SCARA robots, and delta robots; collaborative robots; logistics robots; unmanned forklifts; cleaning robots; serving robots; delivery robots; guide robots; cooking robots; barista robots; security robots; medical robots; quadrupedal robots; military robots; space exploration robots; deep-sea exploration robots; and humanoid robots.

In the present specification, the “multiple types of robots” refers to a case where two or more different types of robots are present. Not only a case where two or more robots having different purposes are present but also a case where two or more robots having the same purpose but different manufacturers are present may be represented by the “multiple types of robots.” Since the object of the inventive concept is to implement the integrated control of multiple types of robots, the “multiple types of robots” may be broadly defined as cases where message format differ due to differences in hardware components or software algorithms, regardless of whether two or more robots have the same purpose, manufacturer, or combination thereof. The “multiple types of robots” may also be represented by “multiple heterogeneous robots.”

Inside the site 10, there may be the one or more pieces of automated equipment 200 in addition to the robots 100. Multiple pieces of automated equipment 200A and 200B having various purposes and functions may be implemented inside the site 10. For example, the pieces of automated equipment 200 may include, but are not limited to, various pieces of automated equipment implemented for human movement, such as an automatic door, an elevator, an escalator, and a speed gate. The pieces of automated equipment 200 may support the movement of the robots 100 by performing actions, such as boarding the robot 100 or allowing the robot 100 to pass through the automated equipment, in conjunction with the integrated control system for multiple types of robots.

Inside the site 10, there may be the one or more persons P who interact with the robot 100 or automated equipment 200. The persons P may each perform various roles depending on the situation. For example, each of the persons P may be an engineer operating a manufacturing robot 100A, a worker working in the same space as a logistics robot 100C, or a customer receiving food from a serving robot 100E, but is not limited thereto. The robots 100 may perform obstacle avoidance to avoid a collision with the person P. When a collision with the person P is anticipated, the robot 100 may pause temporarily or control its drive unit to a path different from a current path.

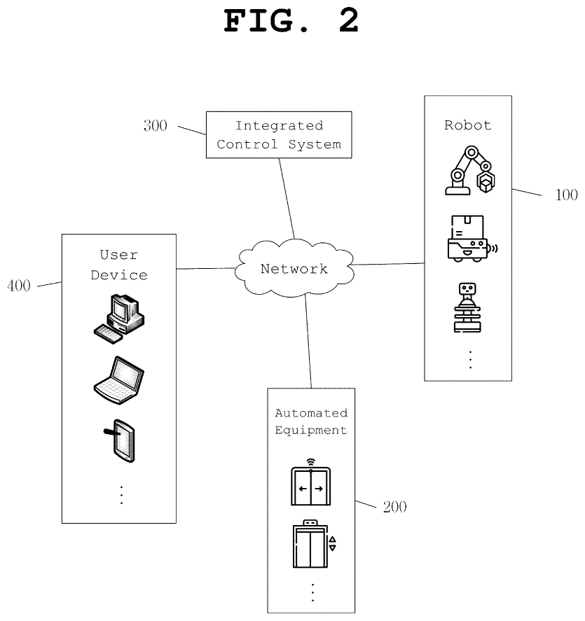

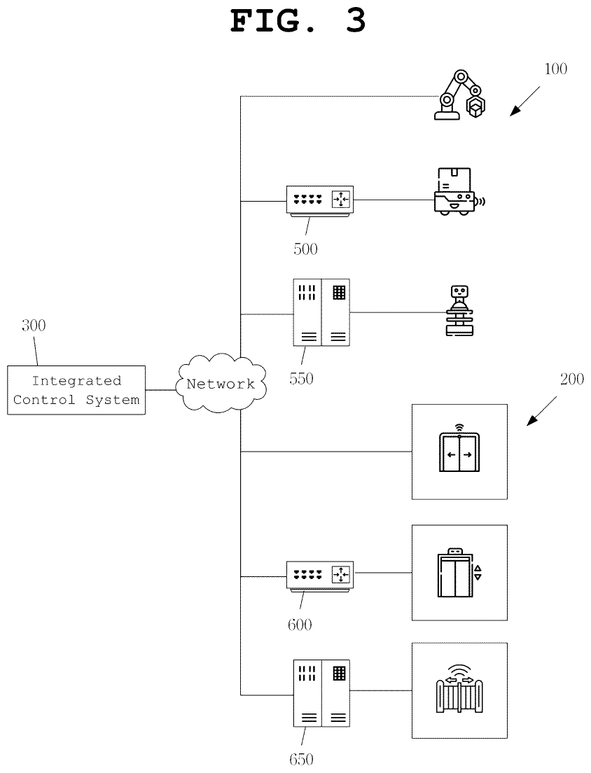

FIG. 2 is a diagram schematically showing a network connection between an integrated control system for multiple types of robots, robots, pieces of automated equipment, and user devices according to one embodiment of the inventive concept, and FIG. 3 is a diagram schematically showing a connection structure between the integrated control system for multiple types of robots, robots, and pieces of automated equipment of FIG. 2.

Referring to FIG. 2, robots 100, pieces of automated equipment 200, an integrated control system 300, and user devices 400 are connected to a network. The robots 100, the pieces of automated equipment 200, the integrated control system 300, and the user devices 400 may transmit and receive various types of data or information over the network.

The network may include a wired network, a wireless network, or a combination thereof capable of transmitting and receiving various types of data or information.

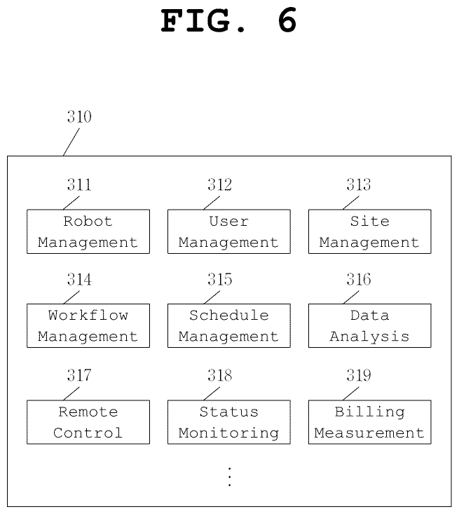

The integrated control system 300 performs integrated control for multiple types of robots 100 introduced into at least one site 10. The integrated control system 300 may remotely control the operations of the robots 100 by transmitting command messages to the robots 100. The integrated control system 300 may monitor the statuses of the robots 100 in real time by receiving status messages from the robots 100. In addition, the integrated control system 300 may perform various control-related functions, which will be described later with reference to FIG. 6. The integrated control system 300 may be implemented in an on-premise system structure inside the site 10, or may be implemented in a cloud system structure outside the site 10.

The user devices 400 each refer to a computing system operated by a user who uses the integrated control system 300. The user devices 400 may each receive commands to perform specific actions from a user, and may output the results of performing the actions to the user. The user devices 400 may include various input and output devices well known in the art to which the inventive concept pertains. For example, the user devices 400 may include, but are not limited to, a smartphone, a desktop computer, a laptop computer, a tablet PC, a smart TV, a digital signage, a wearable device, and/or the like.

Referring to FIG. 3, the connection structure for the transmission and reception of data or information between the integrated control system 300 and the robot 100 may vary. For example, the integrated control system 300 may be directly connected to the robot 100 (or the control panel of the robot 100) over a network, and may transmit and receive messages to and from the robot 100. Alternatively, the integrated control system 300 may be connected to the robot 100 via a relay device 500, and may transmit and receive messages to and from the robot 100. The relay device 500 may include middleware required for communication between the integrated control system 300 and the robot 100, which use different communication methods. For example, the relay device 500 may communicate with the integrated control system 300 via an Application Programming Interface (API) and communicate with the robot 100 by using an industrial communication method such as Modbus, thereby relaying communication between the integrated control system 300 and the robot 100. Alternatively, the integrated control system 300 may be connected to the robot 100 via the manufacturer server 550 of the manufacturer of the robot 100. For example, the integrated control system 300 may communicate with the manufacturer server 550 by using one of various methods, a API such as Representational State Transfer (REST) API and a WebSocket API. The integrated control system 300 may transmit and receive messages to and from the robot 100 via the manufacturer server 550.

The connection structure for the transmission and reception of data or information between the integrated control system 300 and the automated equipment 200 may vary. For example, the integrated control system 300 may be directly connected to the automated equipment 200 over the network, and may transmit and receive messages to and from the automated equipment 200. Alternatively, the integrated control system 300 may be connected to the automated equipment 200 via a relay device 600, and may transmit and receive messages to and from the automated equipment 200. The relay device 600 may include middleware required for communication between the integrated control system 300 and the automated equipment 200, which use different communication methods. For example, the relay device 600 may communicate with the integrated control system 300 via an API and communicate with the automated equipment 200 by using an industrial communication method such as Modbus, thereby relaying communication between the integrated control system 300 and the automated equipment 200. Alternatively, the integrated control system 300 may be connected to the automated equipment 200 via the manufacturer server 650 of the manufacturer of the automated equipment 200. For example, the integrated control system 300 may communicate with the manufacturer server 650 by using various API methods, such as a REST API or a WebSocket API. The integrated control system 300 may transmit and receive messages to and from the automated equipment 200 via the manufacturer server 650.

Although not explicitly shown in FIG. 3, the relay device 600 may be directly connected to the automation equipment 200, or may be connected to the automation equipment 200 via the monitoring or control panel system of the automation equipment 200.

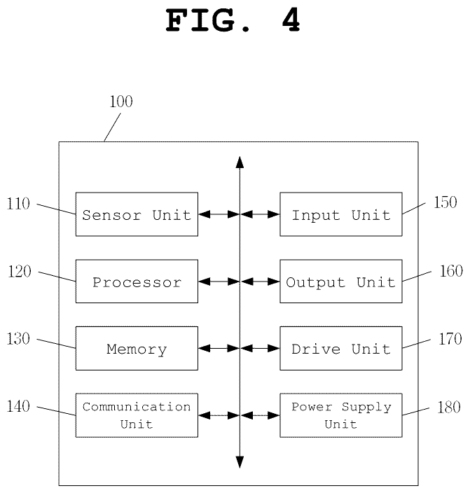

FIG. 4 is a diagram schematically showing an example of the configuration of the robot of FIG. 2.

Referring to FIG. 4, the robot 100 includes a sensor unit 110, a processor 120, memory 130, a communication unit 140, an input unit 150, an output unit 160, a drive unit 170, and a power supply unit 180.

The sensor unit 110 may include one or more sensors for sensing the surrounding environment of the robot 100, the status of a specific internal component of the robot 100, the position of the robot 100, the operator of the robot 100, and/or the like. For example, the sensor unit 110 may include, but is not limited to, an image sensor, an RGBD sensor, a Light Detection And Ranging (LiDAR) sensor, a laser sensor, an ultrasonic sensor, a proximity sensor, an infrared sensor, a force/torque sensor, an inertial sensor, a gyro sensor, an acceleration sensor, a temperature sensor, and/or the like.

The processor 120 performs the general control of the robot 100. The processor 120 may control other internal components of the robot 100, such as the sensor unit 110, the memory 130, the communication unit 140, the input unit 150, the output unit 160, the drive unit 170, and the power supply unit 180. The processor 120 may be implemented to include a Central Processing Unit (CPU), a Micro Processor Unit (MPU), a Micro Controller Unit (MCU), a Graphics Processing Unit (GPU), and/or any other type of processor well known in the art to which the inventive concept pertains. The processor 120 may read one or more instructions or computer programs stored in the memory 130 and execute various commands. The processor 120 may control the robot 100 according to command messages received from the integrated control system 300 via the communication unit 140.

The memory 130 stores one or more instructions, one or more computer programs, data, and/or information for the operation of the robot 100. For example, the memory 130 may include random access memory (RAM), read only memory (ROM), erasable programmable ROM (EPROM), electrically erasable programmable ROM (EEPROM), flash memory, a hard disk, a removable disk, a CD-ROM, and/or any other type of computer-readable storage medium well known in the art to which the inventive concept pertains.

The communication unit 140 may include a wired communication unit, a wireless communication unit, or a combination thereof. The wireless communication unit may include, for example, one or more of a mobile communication module, a wireless Internet module, and a short-range communication module. The mobile communication module may transmit and receive wireless signals to and from at least one of a base station, an external terminal, and a server on a mobile communication network constructed according to mobile communication technology standards or communication methods. The wireless Internet module may transmit and receive wireless signals on a communication network based on wireless Internet technologies. The short-range communication module is intended for short-range communication, and may support short-range communication by using at least one of Bluetooth, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (Wireless USB) technologies.

The input unit 150 may include a camera for inputting video signals, a microphone for receiving audio signals, and a user input unit for receiving information from a user. The image or voice data collected by the input unit 150 may be analyzed and processed into user commands. The user input unit 150 may include a mechanical input means or a touch input means.

The output unit 160 may include one or more of a display unit, an audio output unit, a haptic module, and an optical output unit for generating output related to a visual, auditory, or tactile sensation.

The drive unit 170 provides a means for driving mechanical components of the robot 100. For example, in the case of a manufacturing robot or a quadruped robot, the drive unit 170 includes a means for driving the joints of the robot 100. In the case of a mobile robot, the drive unit 170 may include various means for performing functions such as driving and changing the direction of the robot 100. The drive unit 170 may include various actuators, such as a motor and a reducer.

The power supply unit 180 supplies power for the operation of the robot 100. The power supply unit 180 supplies external power or the internal power (e.g., power from a battery) of the robot 100 to the individual internal components of the robot 100.

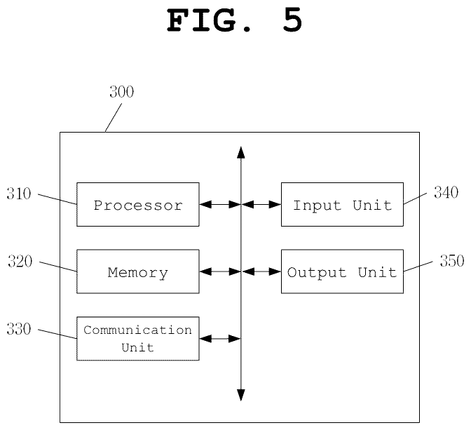

FIG. 5 is a diagram schematically showing the configuration of an integrated control system for multiple types of robots according to one embodiment of the inventive concept.

Referring to FIG. 5, an integrated control system 300 for multiple types of robots includes a processor 310, memory 320, a communication unit 330, an input unit 340, and an output unit 350.

The processor 310 performs the general control of the integrated control system 300 for multiple types of robots. The processor 310 may control other internal components of the integrated control system 300 for multiple types of robots, such as the memory 320, the communication unit 330, the input unit 340, and the output unit 350. The processor 310 may be implemented to include a CPU, an MPU, an MCU, a GPU, or any other type of processor well known in the art to which the inventive concept pertains. The processor 310 may read one or more instructions or computer programs stored in the memory 320 and execute various commands. The processor 310 may control the integrated control system 300 for multiple types of robots according to the commands received from the user devices 400 via the communication unit 330.

The memory 320 stores one or more instructions, one or more computer programs, data, and/or information for the operation of the integrated control system 300 for multiple types of robots. For example, the memory 320 may include RAM, ROM, EPROM, EEPROM, flash memory, a hard disk, a removable disk, a CD-ROM, or any other type of computer-readable storage medium well known in the art to which the inventive concept pertains.

The communication unit 330 may include a wired communication unit, a wireless communication unit, or a combination thereof. The wireless communication unit may include, for example, one or more of a mobile communication module, a wireless Internet module, and a short-range communication module. The mobile communication module may transmit and receive wireless signals to and from at least one of a base station, an external terminal, and a server on a mobile communication network constructed according to mobile communication technology standards or communication methods. The wireless Internet module may transmit and receive wireless signals on a communication network based on wireless Internet technologies. The short-range communication module is intended for short-range communication, and may support short-range communication by using at least one of Bluetooth, RFID, infrared communication, UWB, ZigBee, NFC, Wi-Fi, Wi-Fi Direct, and Wireless USB technology.

The input unit 340 may include a camera for inputting video signals, a microphone for receiving audio signals, and a user input unit for receiving information from the user. The image data or voice data collected by the input unit may be analyzed and processed into user commands. The user input unit may include a mechanical input device or a touch input device.

The output unit 350 may include one or more of a display unit, an audio output unit, a haptic module, and an optical output unit for generating output related to a visual, auditory, or tactile sensation.

The integrated control system 300 for multiple types of robots may be implemented as a single server or multiple servers as needed. When the integrated control system 300 for multiple types of robots is implemented as multiple servers, each of the servers may include the configuration described with reference to FIG. 5.

FIG. 6 is a diagram schematically showing the functions or services performed by an integrated control system for multiple types of robots according to one embodiment of the inventive concept.

Referring to FIG. 6, the processor 310 of the integrated control system 300 for multiple types of robots may execute one or more instructions or computer programs stored in the memory 320, thereby providing various functions or services, such as robot management 311, user management 312, site management 313, workflow management 314, schedule management 315, data analysis 316, remote control 317, status monitoring 318, and billing measurement 319.

For example, the integrated control system 300 for multiple types of robots may provide a robot management function that registers and manages robot types, robot names, and robot identifiers. Furthermore, the integrated control system 300 for multiple types of robots may provide a user management function that registers and manages users having management authority for the respective robots 100. To this end, the integrated control system 300 for multiple types of robots may associate and register robot identifiers, user identifiers, user passwords, and/or the like. Furthermore, the integrated control system 300 for multiple types of robots may provide a site management function that registers and manages site types, site names, site addresses, site floor numbers, site maps, site robots, and points of interest within sites. A user may assign robots, for which he or she has management authority, for each site. Furthermore, the integrated control system 300 for multiple types of robots may provide a workflow management function that constructs, modifies, and manages workflows each defining the sequence of a series of tasks, and controls and monitors the robots 100 according to the workflows. Furthermore, the integrated control system 300 for multiple types of robots may provide a schedule management function that controls each of the robots 100 to perform a predetermined task at a specific time or to repeatedly perform the corresponding task. Furthermore, the integrated control system 300 for multiple types of robots may provide a data analysis function that analyzes various types of data regarding the statuses received from the robots 100 or the commands transmitted to the robots 100 and provides data status and statistics. Furthermore, the integrated control system 300 for multiple types of robots may provide a remote control function that remotely instructs the robots 100 and controls their operations. Furthermore, the integrated control system 300 for multiple types of robots may provide a status monitoring function that monitors various conditions of the robots 100, such as their operational statuses, battery levels, and current locations, in real time. Furthermore, the integrated control system 300 for multiple types of robots may perform a billing measurement function that determines the billing amounts based on the computing resource consumptions of the robots 100, the numbers of network transmissions, and/or the like. The integrated control system 300 for multiple types of robots may provide various functions or services, such as preemptive (preventive) repair & maintenance, remote error resolution, and/or the like, which are not shown in FIG. 6.

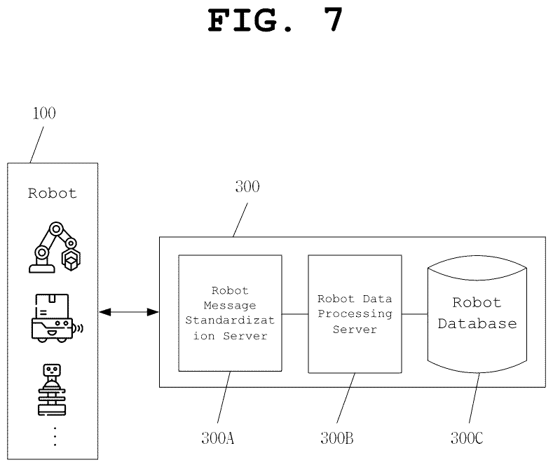

FIG. 7 is a diagram schematically showing the server configuration of an integrated control system for multiple types of robots according to one embodiment of the inventive concept.

Referring to FIG. 7, an integrated control system 300 for multiple types of robots may include various servers for the standardization and processing of the data that is transmitted and received to and from multiple types of robots 100.

In some embodiments, the integrated control system 300 for multiple types of robots may include a robot message standardization server 300A, a robot data processing server 300B, and a robot database 300C.

The integrated control system 300 for multiple types of robots transmits and receives messages to and from the multiple types of robots 100. Since the message format of the multiple types of robots 100 differ, the standardization of robot messages is required for the integrated data processing of the integrated control system 300 for multiple types of robots.

To this end, the robot message standardization server 300A transmits and receives status and command messages to and from the multiple types of robots 100, and performs the standardization of the status messages and the command messages. The robot message standardization server 300A receives status messages in unique format from the multiple types of robots 100, and converts the status messages in the unique format into status messages in a standard format. This sequential conversion will be referred to as “standardization conversion” hereinafter. Furthermore, the robot message standardization server 300A receives command messages in the standard format from the robot data processing server 300B, and converts the command messages in in the standard format into command messages in the unique format. This sequential conversion will be referred to as “de-standardization conversion” hereinafter as the concept opposed to that of “standardization conversion.”

The robot data processing server 300B is connected to the robot message standardization server 300A and the robot database 300C. The robot data processing server 300B may process the data within various messages transmitted and received to and from the robot message standardization server 300A or the data within various pieces of information transmitted and received to and from the user devices 400. The robot data processing server 300B may process the data received from the robot message standardization server 300A or the robot database 300C in response to the requests received from the user devices 400, and may transmit the processed data to the user devices 400. The robot data processing server 300B may generate robot status information corresponding to status messages in the standard format based on the status messages in the standard format received from the robot message standardization server 300A. Furthermore, the robot data processing server 300B may generate command messages in the standard format corresponding to user command information based on the user command information received from the user devices 400.

The robot data processing server 300B may receive status messages in the standard format from the robot message standardization server 300A. The robot data processing server 300B may transmit command messages in the standard format to the robot message standardization server 300A. The robot data processing server 300B may transmit robot status information to the user devices 400. The robot data processing server 300B may receive user command information from the user devices 400.

The robot data processing server 300B may perform data purification intended to remove data errors, omissions, inconsistencies, and overlaps, and/or the like inside the messages transmitted to and received from the robot message standardization server 300A.

The robot data processing server 300B may store data processing results in the robot database 300C. The robot data processing server 300B may query, modify, or delete the data stored in the robot database 300C, or may store new data in the robot database 300C.

The robot database 300C stores various types of data or information within the integrated control system 300 for multiple types of robots. The robot database 300C may store various types of information, such as robot status information, user command information, and alarm information, received from the robot data processing server 300B. The robot database 300C may store status and command messages in a raw state transmitted and received between the robots 100 and the robot message standardization server 300A without passage through data processing by the robot data processing server 300B. For example, the robot database 300C may be implemented to include one or more types of databases among a hierarchical database, a network database, and a relational database, but is not limited thereto. The robot database 300C may be implemented to include one or more database management systems.

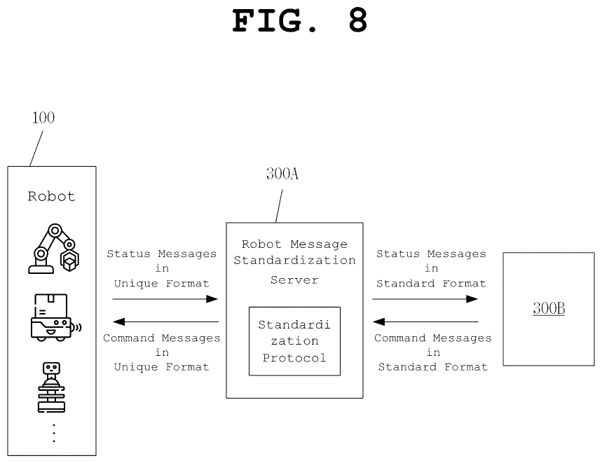

FIG. 8 is a diagram schematically showing message conversion using a standardization protocol according to some embodiments of the inventive concept.

Referring to FIG. 8, a robot message standardization server 300A performs the standardization and de-standardization of messages between multiple types of robots 100 and a robot data processing server 300B by using standardization protocols.

The robot message standardization server 300A transmits and receives status and command messages in unique format to and from the multiple types of robots 100.

In this case, the “unique format” refers to the message format, structure, layout, and/or the like of a corresponding robot, which are uniquely distinguished from those of other robots in the transmission and reception of status and command messages.

In addition, the status message is a message transmitted by the robot 100 to the control system for the status monitoring function of the robot 100. The status message may include various types of status data, such as network connection status data, robot status data, and battery level data. The command message is a message transmitted by the control system to the robot 100 for the remote control function of the robot 100. The command message may include various types of command data, such as movement commands, destination location commands, and emergency stop commands. Hereinafter, the simple term “message” refers to a status message, a command message, or a combination thereof.

For example, in the case of a first-type robot 100 manufactured by a first manufacturer, the robot message standardization server 300A transmits and receives status and command messages in a first unique format to and from the first-type robot 100. In the case of a second-type robot 100 manufactured by a second manufacturer, the robot message standardization server 300A transmits and receives status and command messages in a second unique format to and from the second-type robot 100. When the first and second manufacturers are different from each other, the first and second unique format may also differ from each other. Accordingly, despite having substantially the same meaning, the expressions of data within status messages or command messages may differ from each other.

For example, the keys of the data used to convey that the current operational status of the robot is a driving status may differ, as in the case where they are “state” and “moveState,” and the values thereof may differ, as in the case where they are “move” and “moving.”

Furthermore, even when the manufacturers of the first- and second-type robots 100 are the same, the same situation may arise due to a difference in version, system update, or software upgrade.

The robot message standardization server 300A performs message standardization and de-standardization by using a standardization protocol for various purposes, such as the maintenance of data consistency, the improvement of data quality, efficient data management, and clear communication during the integrated control of the multiple types of robots 100. When direct code modification is applied to message standardization and de-standardization, lots of labor and time are required. In contrast, when a standardization protocol is utilized, message conversion may be mechanically performed without code modification, and thus this is more efficient.

The standardization protocol may include various rules for the conversion of status messages in a unique format into status messages in a standard format and the conversion of command messages in the standard format into command messages in the unique format.

In some embodiments, the standardization protocol may include a plurality of standardization protocols distinguished by the types of robots 100. The robot message standardization server 300A may select a standardization protocol corresponding to a specific robot 100 from among the plurality of standardization protocols based on data such as a robot identifier, robot type data, a standardization protocol identifier, and/or the like within a message in a unique format received from the specific robot 100 or a message in a standard format received from the robot data processing server 300B and set to the specific robot 100 for its recipient.

In some embodiments, the standardization protocol may include a mapping between the data contained in a message in a unique format and the data contained in a message in a standard format.

In some embodiments, data in the messages transmitted and received between the robots 100 and the integrated control system 300 for multiple types of robots may be implemented in a key-value pair structure.

Accordingly, the standardization protocol may include a mapping between the keys and values of specific data within messages in a unique format and the keys and values of specific data within messages in a standard format.

More specifically, the standardization protocol may include a mapping between the source keys and source values of status messages in a unique format and the target keys and target values of status messages in a standard format. In this case, the “source” represents the original value before standardization, and the “target” represents the value after standardization.

Furthermore, the standardization protocol may include a mapping between the source keys and source values of command messages in a standard format and the target keys and target values of command messages in a unique format. In this case, the “source” represents the original value before de-standardization, and the target represents the value after de-standardization.

When the integrated control system 300 for multiple types of robots receives status messages from one or more robots 100, the robot message standardization server 300A receives status messages in unique format from the one or more robots 100, converts the status messages in the unique format into status messages in a standard format according to the standardization protocol, and then transmits the status messages in the standard format to the robot data processing server 300B.

In contrast, when the integrated control system 300 for multiple types of robots transmits command messages to one or more robots 100, the robot message standardization server 300A receives command messages in the standard format from the robot data processing server 300B, converts the command message in the standard format into command messages in unique format according to the standardization protocol, and then transmits the command messages in the unique format to the one or more robots 100.

Thus, the robot data processing server 300B may transmit and receive status and command messages in a standard format to and from the robot message standardization server 300A, rather than directly transmitting and receiving status and command messages in the format of the respective types of robots 100 to and from the multiple types of robots 100.

Meanwhile, by separating the robot message standardization server 300A and the robot data processing server 300B from each other, the performance of each of the servers may be optimized and each of the servers may be independently expanded as needed. Furthermore, when maintenance, such as the update of the standardization protocol, is required, the maintenance may be more easily performed on the robot message standardization server 300A without affecting the robot data processing server 300B.

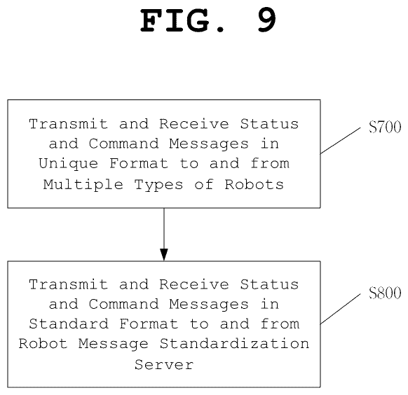

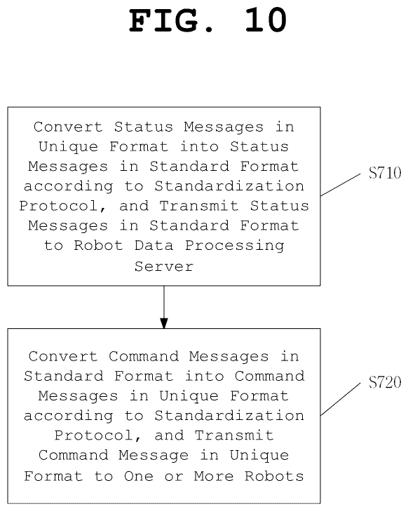

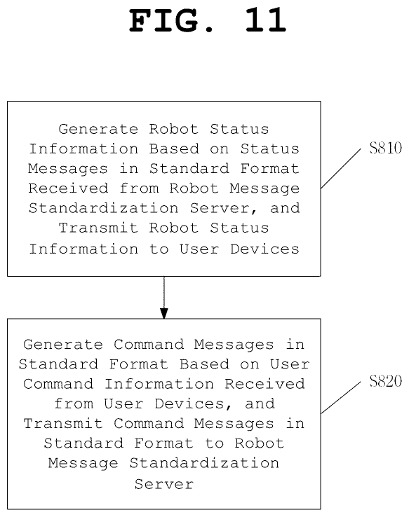

FIG. 9 is a diagram schematically showing an integrated control method for multiple types of robots performed by the integrated control system for multiple types of robots of FIG. 7, FIG. 10 is a diagram schematically showing the detailed configuration of step S700 of FIG. 9, and FIG. 11 is a diagram schematically showing the detailed configuration of step S800 of FIG. 9. For ease of description, detailed descriptions identical to those described with reference to FIGS. 7 and 8 will be omitted.

Referring to FIG. 9, in step S700, the robot message standardization server 300A transmits and receives status and command messages in unique format to and from the multiple types of robots 100.

Thereafter, in step S800, the robot data processing server 300B transmits and receives status and command messages in a standard format to and from the robot message standardization server 300A.

Referring to FIG. 10, in step S710, the robot message standardization server 300A receives status messages in unique format from one or more robots 100, performs standardization conversion from the status messages in the unique format into status messages in a standard format according to the standardization protocol, and transmits the status messages in the standard format to the robot data processing server 300B.

Thereafter, in step S720, the robot message standardization server 300A receives command messages in the standard format from the robot data processing server 300B, performs de-standardization conversion from the command messages in the standard format into command messages in unique format according to the standardization protocol, and transmits the command message in the unique format to one or more robots 100.

Referring to FIG. 11, in step S810, the robot data processing server 300B receives status messages a standard format from the robot message standardization server 300A, generates robot status information based on status messages in the standard format, and transmits the robot status information to the user devices 400 of the robots 100.

Thereafter, in step S820, the robot data processing server 300B receives user command information from the user devices 400 of the robots 100, generates command messages in the standard format based on the user command information, and transmits the command messages in the standard format to the robot message standardization server 300A.

The steps shown in FIGS. 9 to 11 may be further divided into additional steps or combined into fewer steps, depending on the implementation of the inventive concept. Alternatively, some steps may be omitted as needed, or the sequence of steps may be changed. Alternatively, some steps may be performed concurrently.

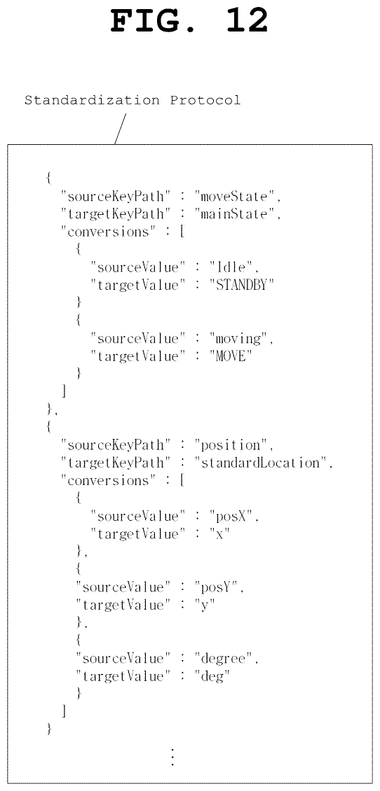

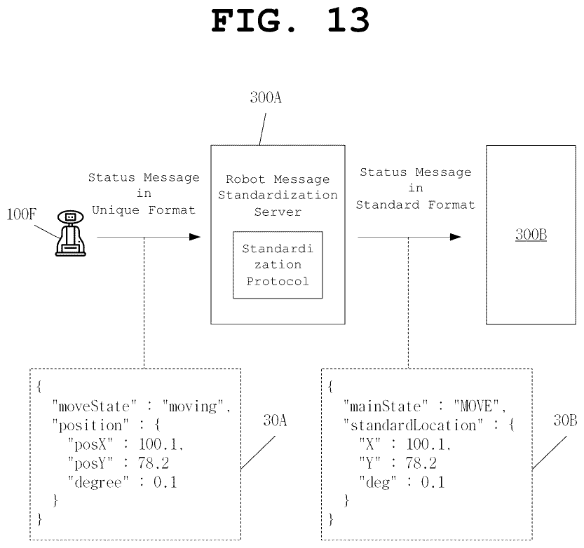

FIG. 12 is a diagram schematically showing an example of a standardization protocol, and FIG. 13 is a diagram schematically showing the process of the standardization conversion of a status message using the example of the standardization protocol of FIG. 12.

Referring to FIG. 12, an example of a standardization protocol is written using the Javascript Object Notation (JSON) format. However, the standardization protocol is not limited to the JSON format, and may be written using various data exchange format, such as Extensible Markup Language (XML) or Comma Separated Values (CSV), which are well known in the art to which the inventive concept pertains.

The example of the standardization protocol of FIG. 12 is directed to a specific robot 100 manufactured by a specific robot manufacturer, and shows standardization rules for data portions regarding the operational status and current location of a robot in a status message.

In the example of the standardization protocol, “sourceKeyPath” represents source keys, and “targetKeyPath” Furthermore, “conversions” represents an represents target keys. array applied to the conversion of values. “sourceValue” represents source values, and “targetValue” represents the target values.

Referring to FIG. 13, the robot message standardization server 300A performs the standardization conversion of a status message 30A in a unique format of a robot 100F into a status message 30B in a standard format by using the example of the standardization protocol of FIG. 12.

Although a cleaning robot 100F is shown as the robot 100 subject to message standardization in FIG. 13, the inventive concept is not limited to this example. The message standardization and de-standardization using the standardization protocol may be applied to a case where multiple types of robots are introduced into the site 10 and the multiple types of robots use messages in different unique format.

Inside the status message 30A in the unique format of the robot 100F, the key for data regarding operational status of the robot 100F is “moveState” and the value therefor is “moving.” In contrast, it can be seen that after standardization conversion, inside the status message 30B in the standard format, the key for data regarding the operational status of the robot 100F is standardized to “mainState” and the value therefor is standardized to “MOVE.”

Furthermore, inside the status message 30A in the unique format of the robot 100F, the key for data regarding the current location of the robot 100F is “position,” and the values therefor are “posx,” “posY,” and “degree.”

In contrast, it can be seen that after standardization, inside the status message 30B in the standard format, the key for data regarding the current location of the robot 100F is standardized to “standardLocation” and the values are standardized to “X,” “Y,” and “deg.”

Meanwhile, although rules for the conversion of command messages and a de-standardization process in the standardization protocol are not explicitly shown, those skilled in the art will understand that are substantially the same as those described with reference to FIGS. 12 and 13, except that the direction of the conversion is reversed.

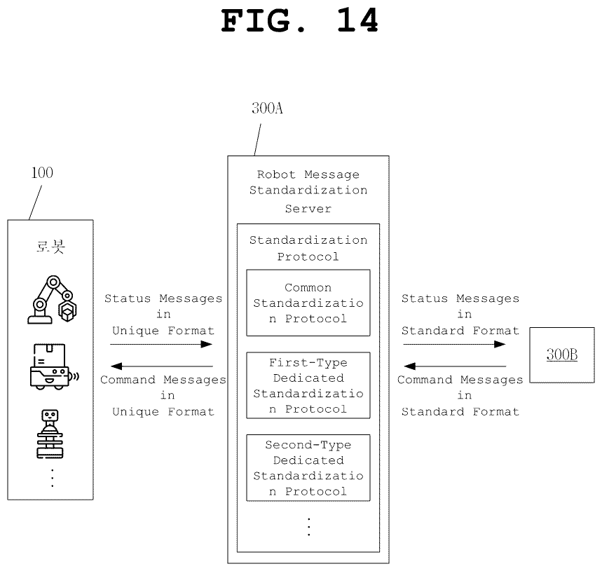

FIG. 14 is a diagram schematically showing message conversion a common standardization protocol and using a dedicated standardization protocol according to some embodiments of the inventive concept. For ease of description, detailed descriptions identical to those described with reference to FIG. 8 will be omitted.

Referring to FIG. 14, the robot message standardization server 300A performs the standardization and de-standardization of messages between multiple types of robots 100 and a robot data processing server 300B by using a standardization protocol including a common standardization protocol and multiple dedicated standardization protocols.

The standardization protocol includes the common standardization protocol for the standardization of common states or commands and the multiple dedicated standardization protocols for the standardization of dedicated states or commands for the multiple types of robots 100. For example, the types of robots may be classified according to their function, but are not limited thereto.

For example, the standardization protocol may include dedicated standardization protocols for various types of robots, such as a dedicated standardization protocol for industrial robots, a dedicated standardization protocol for collaborative robots, a dedicated standardization protocol for logistics robots, a dedicated standardization protocol for cleaning robots, a dedicated standardization protocol for serving robots, and a dedicated standardization protocol for delivery robots.

For example, when there are provided two types of robots (a delivery robot and a cleaning robot) that perform different functions, the standardization protocol may include, in addition to a common standardization protocol, a first-type dedicated standardization protocol for the standardization of dedicated statuses or commands of a first type of robot (the delivery robot) and a second-type dedicated standardization protocol for the standardization of dedicated statuses or commands of a second type of robot (the cleaning robot).

The common standardization protocol is intended for the standardization of common statues or commands among the multiple types of robots 100. In this case, the common statuses or commands are related to common performances or functions of the respective types of the multiple types of robots 100. For example, the common statuses or commands may include, but are not limited to, one or more of the following: robot identifiers, network connection statuses, robot statuses, emergency stop, charging statuses, battery levels, destination locations, origin locations, remaining times to destinations, remaining distances to destinations, robot locations, error occurrence information, and the like.

In some embodiments, the common standardization protocol may include a mapping between data regarding common statuses or commands contained in messages in a unique format and data regarding common statuses or commands contained in messages in a standard format. The common standardization protocol may include a mapping between source keys and values regarding common statuses in status messages in a unique format and target keys and values regarding common statuses in status messages in a standard format. The common standardization protocol may include a mapping between source keys and values regarding common commands in command messages in a standard format and target keys and values regarding common commands in command messages in a unique format.

The dedicated standardization protocol is intended for the standardization of dedicated statuses or commands for the various types of robots 100. In this case, the dedicated statuses or commands are related to additional performances or functions for the respective types of the multiple types of robots 100. For example, the dedicated statuses or commands may include, but are not limited to, one or more of the following: cleaning mode, the presence or absence of guidance schedule setting, and the presence or absence of delivery item loading.

In some embodiments, the dedicated standardization protocol may include a mapping between data regarding dedicated statuses or commands contained in messages in a unique format and data regarding dedicated statuses or commands contained in messages in a standard format. The dedicated standardization protocol may include a mapping between source keys and values for dedicated statuses in status messages in a unique format and target keys and values for dedicated statuses in status messages in a standard format. The dedicated standardization protocol may include a mapping between source keys and values for dedicated commands in command messages in a standard format and target keys and values for dedicated commands in command messages in a unique format.

For example, when a delivery robot and a cleaning robot performing different functions are introduced into a single site 10, status data such as robot identifiers, network connection statuses, and robot statuses may be related to common statuses. Status data such as whether a delivery target item has been loaded may be related to a dedicated status of the delivery robot, and status data such as the cleaning mode may be related to a dedicated status of the cleaning robot.

In some embodiments, the robot message standardization server 300A may select a dedicated standardization protocol corresponding to the type of a specific robot 100 from among multiple dedicated standardization protocols based on data such as a robot identifier, robot type data, and/or a standardization protocol identifier within a message in a unique format received from the specific robot 100 or a message in a standard format received from a robot data processing server 300B and set to the specific robot 100 for its recipient.

When the integrated control system 300 for multiple types of robots receives status messages from one or more first-type robots 100, the robot message standardization server 300A receives status messages in the unique format of the first-type robots 100 from one or more first-type robots 100, converts the status messages in the unique format of the first-type robots 100 into status messages in the standard format of the first-type robots 100 according to the standardization protocol, and then transmits the status messages in the standard format of the first-type robots 100 to the robot data processing server 300B.

In this case, the robot message standardization server 300A performs standardization conversion for common statuses within the status messages in the unique format of the first-type robots 100 by using a common standardization protocol, and performs standardization conversion for dedicated statuses within the status messages in the unique format of the first-type robots 100 by using a first-type dedicated standardization protocol.

In contrast, when the integrated control system 300 for multiple types of robots transmits command messages to one or more first-type robots 100, the robot message standardization server 300A receives command messages in the first-type standard format from the robot data processing server 300B, converts the command messages in the first-type standard format into command messages in the unique format of the first-type robots 100 according to the standardization protocol, and then transmits the command messages in the unique format of the first-type robots 100 to the first-type robots 100.

In this case, the robot message standardization server 300A performs de-standardization conversion for common commands within the command messages in the first-type standard format by using a common standardization protocol, and performs de-standardization conversion for dedicated commands within the status messages in the first-type standard format by using a first-type dedicated standardization protocol.

When the integrated control system 300 for multiple types of robots receives status messages from one or more second-type robots 100, the robot message standardization server 300A receives status messages in the unique format of the second-type robots 100 from the second-type robots 100, converts the status messages in the unique format of the second-type robots 100 into status messages in the second-type standard format according to the standardization protocol, and then transmits the status messages in the second-type standard format to the robot data processing server 300B.

The standardization conversion using the common standardization protocol and the second-type dedicated standardization protocol for status messages in the unique format of the second-type robots 100 is substantially the same as described above for the status messages in the unique format of the first-type robots 100.

In contrast, when the integrated control system 300 for multiple types of robots transmits command messages to one or more second-type robots 100, the robot message standardization server 300A receives command messages in the second-type standard format from the robot data processing server 300B, converts the command messages om the second-type standard format into command messages in the unique format of the second-type robots 100 according to the standardization protocol, and then transmits the command messages in the unique format of the second-type robots 100 to the second-type robot.

The de-standardization conversion using the common standardization protocol and the second-type dedicated standardization protocol for command messages in the second-type standard format is substantially the same as described above for the command messages in the first-type standard format.

In some embodiments, standard status messages may include multiple different types of standard status messages for the respective types of robots, and standard command messages may include multiple different types of standard command messages for the respective types of robots. For example, the standard status messages may include a first type of standard status message and a second type of standard status message. Furthermore, the standard command messages may include a first type of standard command message and a second type of standard command message. In the case where robot types are classified according to their function, even when the unique format of the messages differ for various reasons and when two or more robots 100 have the same functional (for example, when they are all serving robots having the same functional), the standard status messages and standard command messages of the two or more robots 100 have the same format.

The robot message standardization server 300A utilizes a standardization protocol including a common standardization protocol and multiple dedicated standardization protocols, thus enabling the more efficient standardization of messages from robots having various functions and also increasing the flexibility of message standardization and de-standardization conversion. The robot message standardization server 300A reduces unnecessary computing resource consumption by using only dedicated standardization protocols corresponding to the types of robots 100 introduced into the site 10. Furthermore, when maintenance, such as the update of the standardization protocol, is required, only the dedicated standardization protocol may be updated without affecting the common standardization protocol, or conversely, only the common standardization protocol may be updated without affecting the dedicated standardization protocols. Furthermore, when a new type of robot is added to the control targets, the standardization protocol may be updated more easily by adding a dedicated standardization protocol for the corresponding type of robot.

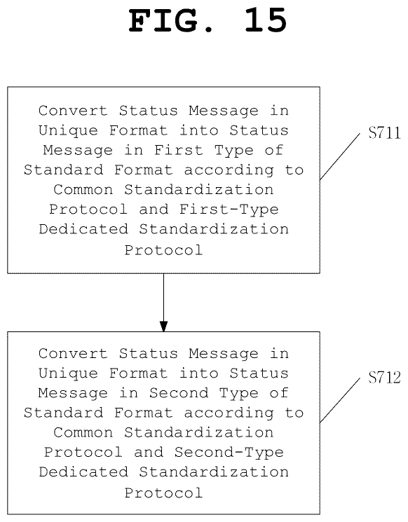

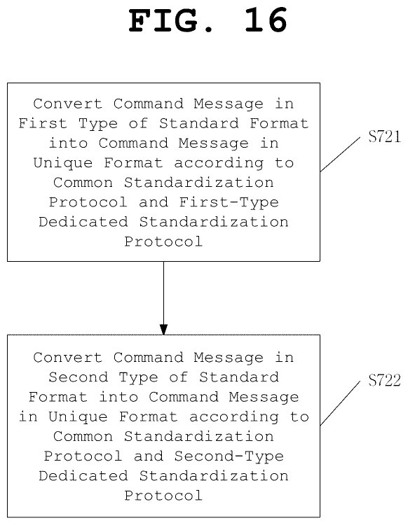

FIG. 15 is a diagram schematically showing the detailed configuration of step S710 of FIG. 10, and FIG. 16 is a diagram schematically showing the detailed configuration of step S720 of FIG. 10. For ease of description, detailed descriptions identical to those described with reference to FIG. 14 will be omitted.

Referring to FIG. 15, the robot message standardization server 300A performs standardization conversion according to the standardization protocol, depending on the type of robot, as follows:

In step S711, the robot message standardization server 300A converts a status message in a unique format, transmitted by a first-type robot 100, into a status message in a first type of standard format according to a common standardization protocol and a first-type dedicated standardization protocol.

Thereafter, in step S712, the robot message standardization server 300A converts a status message in a unique format, transmitted by a second-type robot 100, into a status message in a second type of standard format according to the common standardization protocol and a second-type dedicated standardization protocol.

Referring to FIG. 16, the robot message standardization server 300A performs de-standardization conversion according to the standardization protocol, depending on the type of robot, as follows:

In step S721, the robot message standardization server 300A converts a command message in a first type of standard format into a command message in the unique format of the first-type robot 100 according to the common standardization protocol and the first-type dedicated standardization protocol.

Thereafter, in step S722, the robot message standardization server 300A converts a command message in a second type of standard format into a command message in the unique format of the second-type robot 100 according to the common standardization protocol and the second-type dedicated standardization protocol.

The steps shown in FIGS. 15 and 16 may be further divided into additional steps or combined into fewer steps, depending on the implementation of the inventive concept. Alternatively, some steps may be omitted as needed, or the sequence of steps may be changed. Alternatively, some steps may be performed concurrently.

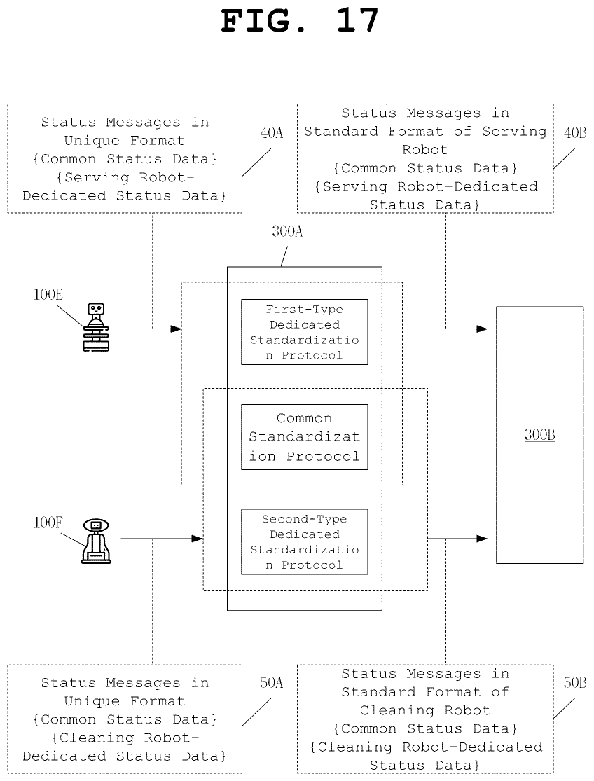

FIG. 17 is a diagram schematically showing an example of the process of the standardization conversion of status messages using a common standardization protocol and dedicated standardization protocols according to some embodiments of the inventive concept.

Referring to FIG. 17, the robot message standardization server 300A performs the standardization conversion of a status message 40A in the unique format of a first-type robot 100E into a status message 40B in a standard format and the standardization conversion of a status message 50A in the unique format of a second-type robot 100F into a status message 50B in the standard format by using a common standardization protocol, a first-type dedicated standardization protocol, and a second-type dedicated standardization protocol.

Although the serving robot 100E is shown as the first-type robot 100E and also the cleaning robot 100F is shown as the second-type robot 100F in FIG. 17, the inventive concept is not limited to this example. The message standardization and de-standardization using the standardization protocol, including the common standardization protocol and the dedicated standardization protocols, may be applied to a case where multiple different types of robots are introduced into a site 10 and the multiple different types of robots use messages in different unique format.

The robot message standardization server 300A performs the standardization conversion of the keys and values of data regarding common states within the status messages 40A and 50A in unique format received from the respective robots 100E and 100F into the key and value values of data regarding common states within status messages 40B and 50B in a standard format by using the common standardization protocol.

The robot message standardization server 300A performs the standardization conversion of the keys and values of data regarding dedicated statuses within a status message 40A in a unique format received from the first-type robot 100E into the keys and values of data regarding dedicated statuses within a status message 40B in a standard format by using the first-type dedicated standardization protocol.

The robot message standardization server 300A performs the standardization conversion of the keys and values of data regarding dedicated statuses within the status message 50A in the unique format received from the second-type robot 100F into the keys and values of data regarding dedicated statuses within the status message 50B in the standard format by using the second-type dedicated standardization protocol.

Meanwhile, although rules for the conversion of command messages and a de-standardization process in the standardization protocol are not explicitly shown, those skilled in the art will understand that they are substantially the same as those described with reference to FIG. 17, except that the direction of the conversion is reversed.

Although not explicitly shown, the robot data processing server 300B may provide a user interfaces to the user device 400 based on a message in the standard format. The robot data processing server 300B may provide a user interface corresponding to data regarding statuses or commands within the message in the standard format. For example, the user interface may include a visual means corresponding to keys or values within the message in the standard format.

The robot data processing server 300B may provide a different type of user interface based on a message in the standard format of each type of robot. A user interface for each robot may include a common user interface portion that is common regardless of the type of robot and a dedicated user interface portion that differs for each type of robot.

The robot data processing server 300B may provide the first-type robot with a user interface including a common user interface portion and a first-type e dedicated user interface portion. The robot data processing server 300B may provide the second-type robot with a user interface including a common user interface portion and a second-type dedicated user interface portion.

The robot data processing server 300B may provide the user device 400 of the first-type robot 100 with a common user interface portion, corresponding to a common state or command, and a first-type dedicated user interface portion, corresponding to a dedicated state or command of the first-type robot 100, based on a message in a first type of standard format.

The robot data processing server 300B may provide the user device 400 of the second-type robot 100 with a common user interface portion, corresponding to a common state or command, and a second-type dedicated user interface portion, corresponding to a dedicated state or command of the second-type robot 100, based on a message in a second type of standard format.

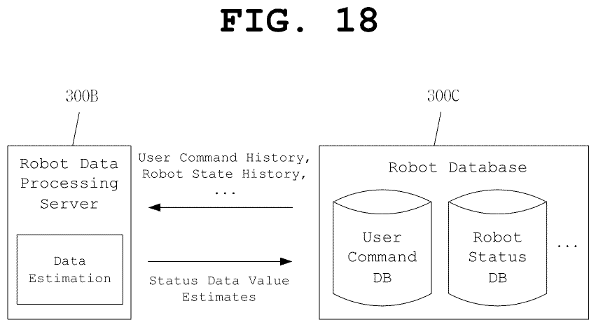

FIG. 18 is a diagram schematically showing estimating missing status data by using a robot database according to some embodiments of the inventive concept.

Referring to FIG. 18, a robot data processing server 300B estimates the values of one or more pieces of missing status data within a status message in a standard format of the one or more robots 100 received from the robot message standardization server 300A when there are the one or more pieces of missing status data within the status message.

The robot data processing server 300B may utilize data or information stored in a robot database 300C to estimate the values of the one or more pieces of missing status data. For example, the robot data processing server 300B may estimate the values of the one or more pieces of missing status data based on a user command history, a robot status history, or a combination thereof stored in the robot database 300C.

For example, the user command history may include records and change details of various types of user command data transmitted by the integrated control system 300 for multiple types of robots to the robots 100, such as robot identifiers, work (or task) execution commands, work stop commands, pause commands, operation mode setting commands, movement commands, starting locations, destination locations, charging commands, move-to-standby location commands, emergency stop commands, map update commands, floor movement (boarding an elevator) commands, command transmission times (timestamps), and/or the like.

For example, the robot status history may include records and change details of various types of robot status data received from the robots 100 by the integrated control system 300 for multiple types of robots, such as the robot identifiers, network connection statuses, robot statuses, emergency stop statuses, charging statuses, battery levels, starting locations, destination locations, remaining times to destinations, remaining distances to destinations, robot locations, error occurrence data, status reception times (timestamps), and/or the like.

In some embodiments, the robot database 300C may include a plurality of databases each storing various types of information, such as robot status information, user command information, alarm information, and/or the like. For example, the robot database 300C may include, but is not limited to, a robot status database for storing robot status information, a user command database for storing user command information, and an alarm database for storing alarm information.

In some embodiments, the robot data processing server 300B may estimate the value of first status data out of the one or more pieces of missing status data based on the data history stored in the robot database 300C. For example, when the “robot status” is missing from a status message in the standard format of the robot 100, the robot data processing server 300B may refer to the user command history of the robot 100 stored in the user command database by using the “robot identifier.” Furthermore, the robot data processing server 300B may estimate the value of the “robot status” missing from the status message in the standard format based on the records and change details of data transmitted by the integrated control system 300 for multiple types of robots to the robots 100, such as work (or task) execution commands, work stop commands, pause commands, operation mode setting commands, movement commands, move-to-standby location commands, emergency stop commands, and/or the like. For example, when the command transmitted by the integrated control system 300 for multiple types of robots to the robot 100 at the closest point in time to the present is a movement command to move to a specific destination, the robot data processing server 300B may estimate the value of the “robot status” as “moving.”

In some embodiments, the robot data processing server 300B may perform the above estimation in such a manner as to replace the value of second status data out of the one or more pieces of missing status data with the one or more values of the data history stored in the robot database 300C. For example, when the “starting location” and the “destination location” are missing from the status message in the standard format of the robot 100, the robot data processing server 300B may refer to the user command history of the robot 100 stored in the user command database by using the “robot identifier.” Furthermore, the robot data processing server 300B may replace the values of the “destination position” and “starting position” missing from the status message in the standard format with the “starting location” and “destination location” values transmitted together with a movement command by the integrated control system 300 for multiple types of robots to the robot 100 at the closest point in time to the present. Even in the case where the “starting location” and the “destination location” are missing from the status message transmitted by a specific robot 100 to the integrated control system 300 for multiple types of robots, when the robot 100 is in the state of operating normally, it will move from the starting location, commanded by the integrated control system 300 for multiple types of robots, toward the destination location. Accordingly, it may be possible to replace the values of the “destination location” and “starting location” missing from the status message in the standard format with the values of the “starting location” and “destination location” transmitted together with the movement command by the integrated control system 300 for multiple types of robots to the robot 100.

In some embodiments, the robot data processing server 300B may perform the above estimation in such a manner as to compute the value of third status data out of the one or more pieces of missing status data based on one or more values of the data history stored in the robot database 300C. For example, when the “remaining distance to destination” or “remaining time to destination” is missing from a status message in the standard format of the robot 100, the robot data processing server 300B may refer to the robot status history of the robot 100 stored in the robot status database by using the “robot identifier.” Furthermore, the robot data processing server 300B may compute the value of the “remaining distance to destination” missing from the status message in the standard format based on the values of the “robot location” and the “destination location” received at the closet point in time to the present from the robot 100 by the integrated control system 300 for multiple types of robots. The robot data processing server 300B may compute the moving speed of the robot based on the change details of the “robot location” stored in the robot status database, and may also compute the value of the “time remaining to destination” missing from the status message in the standard format based on the moving speed of the robot and the value the “remaining distance to destination”.

In some embodiments, the robot data processing server 300B may perform the above estimation on some types of status data within status messages in the standard format of one or more robots 100. As described above, the status messages in the standard format may include common statuses related to the common performances or functions of multiple types of robots 100, and dedicated statuses related to additional performances or functions for each type of the multiple types of robots 100. For example, the robot data processing server 300B may perform the above estimation when one or more pieces of status data are missing from the common statuses. The integrated control system 300 for multiple types of robots is intended to provide a consistent and unified user interface to the user devices 400 despite the differences in messages in the unique format of the multiple types of robots 100. The reason for this is that in this regard, the importance of preventing the omission of data related to the common statuses of the multiple types of robots 100 is relatively high.

In some embodiments, the robot data processing server 300B may perform the above estimation on all types of status data within status messages in the standard format of the one or more robots 100.

After completing the estimation, the robot data processing server 300B may store status data value estimates in the robot database 300C.

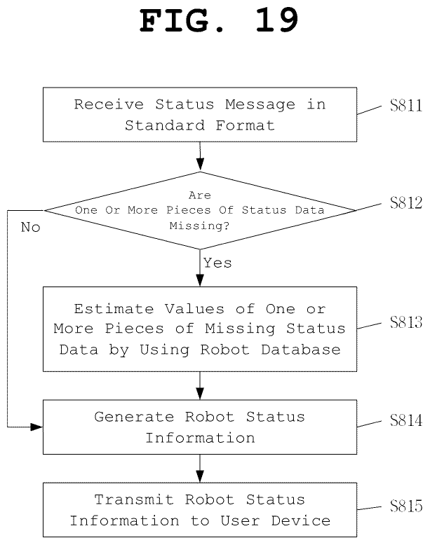

FIG. 19 is a diagram schematically showing the detailed configuration of step S810 of FIG. 11. For ease of description, detailed descriptions identical to those described with reference to FIG. 18 will be omitted.

Referring to FIG. 19, the robot data processing server 300B performs the estimation of the values of status data missing from status messages in a standard format, as follows:

In step S811, the robot data processing server 300B receives a status message in the standard format of the one or more robots 100 from the robot message standardization server 300A.

Thereafter, in step S812, the robot data processing server 300B determines whether one or more pieces of status data are missing from the status messages in the standard format of the one or more robots 100.

Thereafter, in step S813, when it is determined that the one or more pieces of status data are missing, the robot data processing server 300B estimates the values of the one or more pieces of missing status data by using the robot database 300C.

Thereafter, in step S814, the robot data processing server 300B generates robot status information and stores it in the robot database 300C. When the one or more pieces of status data are missing, the robot data processing server 300B generates robot status information based on the status messages in the standard format received from the robot message standardization server 300A. When the values of the one or more pieces of missing g status data are estimated, the robot data processing server 300B generates robot status information based on the status messages in the standard format, received from the robot message standardization server 300A, and the estimated values.

Thereafter, in step S815, the robot data processing server 300B transmits the robot status information to the user device 400 of the robot 100.

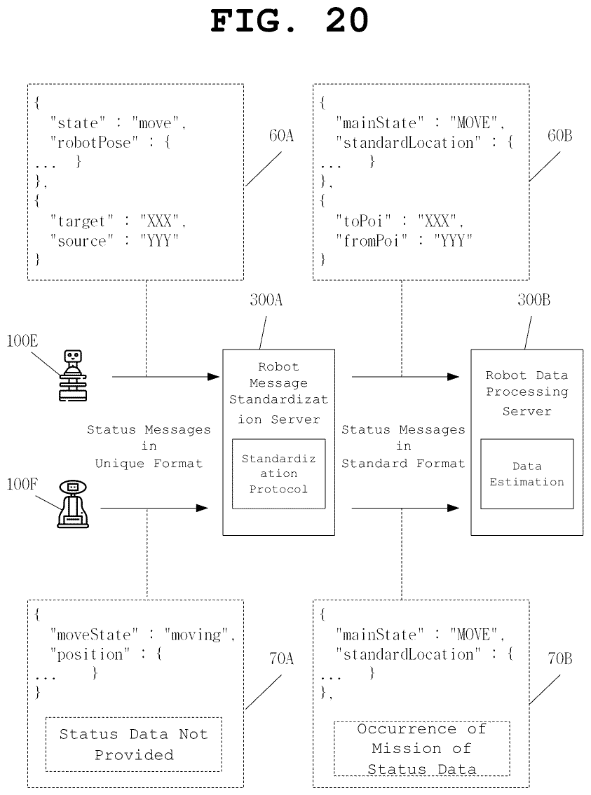

FIG. 20 is a diagram schematically showing an example of the status data omission that occurs during the process of the conversion of status messages using a standardization protocol according to some embodiments of the inventive concept.

Referring to FIG. 20, a robot message standardization server 300A performs the standardization conversion of a status message 60A in the unique format of a first-type robot 100E into a status message 60B in a standard format and the standardization conversion of a status message 70A in the unique format of a second-type robot 100F into a status message 70B in the standard format by using a standardization protocol.

The robot message standardization server 300A performs the standardization conversion of the keys and values of various types of data within the status messages 60A and 70A in unique format received from the respective robots 100E and 100F into the keys and values of various types of data within the status messages 60B and 70B in the standardization format by using the standardization protocol.

In this case, as shown in FIG. 20, the status message 60A in the unique format of the first-type robot 100E includes status data regarding a destination location (“target”) and an origin location (“source”). In contrast, the status message 70A in the unique format of the second-type robot 100F may not include status data regarding a destination location and an origin location.

Although a serving robot is shown as the first-type robot 100E and also a cleaning robot is shown as the second-type robot 100F in FIG. 20, the inventive concept is not limited to this example. The omission of status data may also occur in the case where the same type of multiple robots are introduced into a site 10 and the same type of multiple robots use messages in different unique format.

A robot manufacturer may not provide status data, stored within the robots 100 or within the server of the manufacturer of the robots 100, to the outside for various reasons, such as information security or data sharing policies. This may be the reason why the status message 70A in the unique format of the second-type robot 100F does not inherently include status data regarding the destination and origin locations.

When predetermined status data is fundamentally not present in a status message in the unique format of the robot 100, one or more pieces of status data will be missing from a status message in the standard format corresponding to the predetermined status In this case, the robot message standardization server data. 300A has no choice but to transmit the status message in the standard format with the one or more pieces of status data missing therefrom to the robot data processing server 300B.

As described above, the robot data processing server 300B may determine that one or more pieces of status data are missing from the status message 70B in the standard format regarding the second-type robot 100F, and may estimate the values of the one or more pieces of missing status data by using the robot database 300C.

Although not explicitly shown, the standardization protocol shown in FIG. 20 may include the common standardization protocol and the dedicated standardization protocols described with reference to FIGS. 14 and 17.

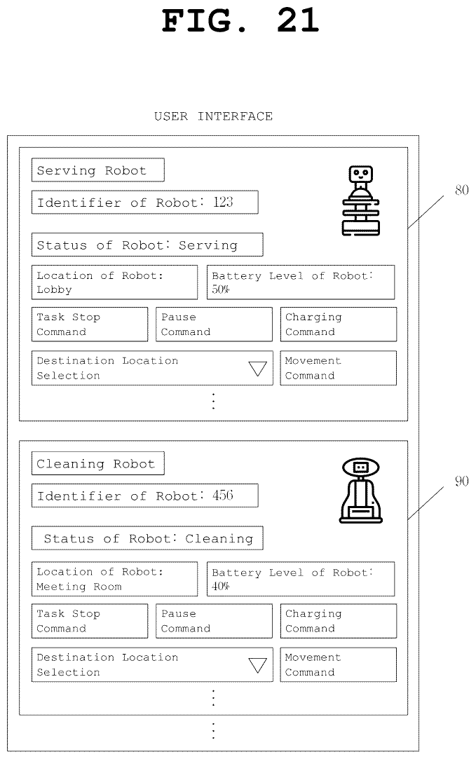

FIG. 21 is a diagram schematically showing an example of the user interface of an integrated control system for multiple types of robots according to some embodiments of the inventive concept.

Referring to FIG. 21, the integrated control system 300 for multiple types of robots provides a user interface to the user device 400 of the robot 100. The user interface may be used for the remote control and real-time monitoring of the robot 100 introduced into the site 10.

The integrated control system 300 for multiple types of robots performs the standardization conversion of status and command messages in the unique format of the robot 100 by using a standardized protocol, and provides a user interface in association with the status and command messages in a standard format obtained through the conversion. Therefore, even when the multiple types of robots 100 introduced into the site 10 are from different manufacturers, a consistent and unified user interface may be provided to the user devices 400.

The example of the user interface shown in FIG. 21 includes an area 80 corresponding to a first-type robot 100 and an area 90 corresponding to a second-type robot 100. Even when the unique format of status and command messages differ for the first- and second-type robots 100 because the manufacturers of the first- and second-type robots 100 differ, the areas 80 and 90 corresponding to the first- and second-type robots 100, respectively, may provide a standardized user interface for various robot statuses and user commands, such as robot robot locations, robot battery identifiers, robot statuses, levels, work stop commands, pause commands, charging commands, destination location selections, and movement commands because the standardization conversion has been undergone.

When the integrated control system for multiple types of robots according to some embodiments is not provided, the user devices 400 will inconveniently have to use robot control systems provided by a plurality of manufacturers, respectively. Furthermore, even in the case where the integrated control system for multiple types of robots is provided, when the message standardization (or de-standardization) conversion according to some embodiments is not applied, a user will experience confusion and difficulties in remote control or real-time monitoring. That is, in the example of the user interface of FIG. 21, data names corresponding to keys and data values corresponding to values will be expressed in different manners notwithstanding that they have substantially the same meanings. Furthermore, when the estimation of missing status data according to some embodiments is not performed, a user interface having data omissions related to some robots 100 will be exposed to the user.

In some embodiments, the above-discussed method of FIG. 9, according to this disclosure, is implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIG. 9 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to the disclosed embodiment, it may be possible to, when one or more pieces of status data are missing from a status message in a standard format, estimate the values of the missing status data based on the user command history or robot status history stored in a robot database while converting a status message in the unique format of a robot into a status message in a standard format by using a standardization protocol, thereby, in the integrated control of multiple types of robots, even when the ranges of robot status data provided to the outside differ for various reasons, estimating the values of missing status data so that data omissions are not exposed to a user and also providing a consistent and unified user interface regardless of the type of robot.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. An integrated control system for multiple types of robots, the integrated control system comprising:
a robot message standardization server configured to transmit and receive status and command messages in unique format to and from multiple types of robots; and
a robot data processing server configured to transmit and receive status and command messages in a standard format to and from the robot message standardization server;
wherein the robot message standardization server:
receives status messages in the unique format from the multiple types of robots, converts the status messages in the unique format into status messages in the standard format according to a standardization protocol, and transmits the status messages in the standard format to the robot data processing server; and
receives command messages in the standard format from the robot data processing server, converts the command messages in the standard format into command messages in the unique format according to the standardization protocol, and transmits the command messages in the unique format to the multiple types of robots; and
wherein the robot data processing server:
generates robot status information based on the status messages in the standard format received from the robot message standardization server, and transmits the robot status information to user devices of the integrated control system for multiple types of robots;
generates command messages in the standard format based on user command information received from the user devices, and transmits the command messages in the standard format to the robot message standardization server; and
when for one or more robots, one or more pieces of status data are inherently missing from the status messages in the unique format and thus one or more pieces of status data are omitted from the status messages in the standard format, estimates values of the one or more pieces of missing status data based on a user command history stored in a robot database.

2. The integrated control system of claim 1, wherein the robot data processing server:
replaces a value of first state data out of the one or more pieces of missing state data with one or more values of a first history stored in the robot database; or
computes a value of second data out of the one or more pieces of missing state data based on one or more values of a second history stored in the robot database.

3. The integrated control system of claim 1, wherein the robot data processing server provides a common user interface to the user devices based on the status and command messages in the standard format for the multiple types of robots.

4. The integrated control system of claim 1, wherein the robot data processing server generates robot status information based on the status messages in the standard format received from the robot message standardization server and the estimated values of the one or more pieces of status data for the one or more robots.

5. The integrated control system of claim 1, wherein:
the status messages in the standard format each include common statuses regarding common performances or functions of the multiple types of robots and dedicated statuses regarding additional performances or functions for each type of the multiple types of robots; and
the robot data processing server estimates values of the one or more pieces of missing status data by using the robot database when the one or more pieces of status data are missing from the common statuses.

6. An integrated control method for multiple types of robots, the integrated control method being performed by an integrated control system for multiple types of robots including a robot message standardization server and robot data processing server, the integrated control method comprising:
transmitting and receiving, by the robot message standardization server, status and command messages in unique format to and from multiple types of robots; and
transmitting and receiving, by the robot data processing server, status and command messages in a standard format to and from the robot message standardization server;
wherein transmitting and receiving the status and command messages in the unique format comprises:
by the robot message standardization server,
receiving status messages in the unique format from the multiple types of robots, converting the status messages in the unique format into status messages in the standard format according to a standardization protocol, and transmitting the status messages in the standard format to the robot data processing server; and
receiving command messages in the standard format from the robot data processing server, converting the command messages in the standard format into command messages in the unique format according to the standardization protocol, and transmitting the command messages in the unique format to the multiple types of robots; and
wherein transmitting and receiving the status and command messages in the standard format comprises:
by the robot data processing server,
generating robot status information based on the status messages in the standard format received from the robot message standardization server, and transmitting the robot status information to user devices of the integrated control system for multiple types of robots;
generating command messages in the standard format based on user command information received from the user devices, and transmitting the command messages in the standard format to the robot message standardization server; and
when for one or more robots, one or more pieces of status data are inherently missing from the status messages in the unique format and thus one or more pieces of status data are omitted from the status messages in the standard format, estimating values of the one or more pieces of missing status data based on a user command history stored in a robot database.

7. The integrated control method of claim 6, wherein estimating the values of the one or more pieces of missing status data comprises:
replacing a value of first state data out of the one or more pieces of missing state data with one or more values of a first history stored in the robot database; or
computing a value of second data out of the one or more pieces of missing state data based on one or more values of a second history stored in the robot database.

8. The integrated control method of claim 6, wherein transmitting and receiving the status and command messages in the standard format comprises providing, by the robot data processing server, a common user interface to the user devices based on the status and command messages in the standard format for the multiple types of robots.

9. The integrated control method of claim 6, wherein transmitting the robot status information to the user devices comprises generating, by the robot data processing server, robot status information based on the status messages in the standard format received from the robot message standardization server and the estimated values of the one or more pieces of status data for the one or more robots.

10. The integrated control method of claim 6, wherein:
the status messages in the standard format each comprise common statuses regarding common performances or functions of the multiple types of robots and dedicated statuses regarding additional performances or functions for each type of the multiple types of robots; and
estimating the values of the one or more pieces of missing status data comprises estimating values of the one or more pieces of missing status data by using the robot database when the one or more pieces of status data are missing from the common statuses.
